(19) United States
(12) Patent Application Publication
(10) Pub. No.: US 2015/0278731 A1
(43) Pub. Date: Oct. 1, 2015

(54) GENERATING A FUNCTIONAL PERFORMANCE INDEX ASSOCIATED WITH SOFTWARE DEVELOPMENT

(71) Applicant: Scrum.org, Burlington, MA (US)

(72) Inventors: Joseph Kent Schwaber, Lexington, MA (US); Eva B. Bitteker, Arlington, MA (US); Gunther Verheyen, Ekeren (BE); Patricia M. Kong, Melrose, MA (US); Christina S. Schwaber, Lexington, MA (US)

(73) Assignee: Scrum.org, Burlington, MA (US)

(21) Appl. No.: 14/227,688

(22) Filed: Mar. 27, 2014

(51) Int. Cl. G06Q 10/06

(52) U.S. Cl. CPC G06Q 10/0639

(57) ABSTRACT

Methods and apparatuses, including computer program products, are described for generating an index of functional performance associated with software development. A server computing device receives software development performance data associated with a company, the software development performance data distributed among a plurality of categories and corresponding to a first period of time. The server computing device determines a current score for each of the plurality of categories based upon the software development performance data associated with the category. The server computing device aggregates the current scores for each of the plurality of categories to generate a current index score for the company for the first period of time. The server computing device compares the current index score to index scores for the company corresponding to prior periods of time to determine a change in index score over time.

### FIELD OF THE INVENTION

This application relates generally to methods and apparatuses, including computer program products, for generating a functional performance index associated with software development.

### BACKGROUND

Software has become an integral part of most people's lives, and companies that have never considered themselves to be players in the technology market are competing on their software capabilities. For benefits such as better alignment of IT and business stakeholders, increased predictability and lowered risk, agile methods of software development (such as Scrum co-developed by Ken Schwaber of Scrum.org of Burlington, Mass.) have become an industry standard for most organizations.

However, it can be difficult to effectively measure the impact of the software development organization using metrics focused on cost containment and process (i.e., metrics of time, scope, budget). Many organizations have adapted their software delivery methods but not their ways of measuring success data points and even if they did, understandable performance metrics cannot be easily gleaned without an effective evaluation framework in place.

### SUMMARY OF THE INVENTION

Therefore, what is needed are methods and systems to capture a company's software development performance data and generate a functional performance index (also called an agility index) that represents the company's success in software development. The techniques described herein provide the advantage of a robust, integrated system and method for generating a functional performance index based upon data provided by the company and for tracking changes to the company's functional performance index over time—enabling the company to recognize how improvements to its software development infrastructure impacts the success of its development.

The invention, in one aspect, features a computerized method for generating a functional performance index associated with software development. A server computing device receives software development performance data associated with a company, the software development performance data distributed among a plurality of categories and corresponding to a first period of time. The server computing device determines a current score for each of the plurality of categories based upon the software development performance data associated with the category. The server computing device aggregates the current scores for each of the plurality of categories to generate a current index score for the company for the first period of time. The server computing device compares the current index score to index scores for the company corresponding to prior periods of time to determine a change in index score over time.

The invention, in another aspect, features a system for generating a functional performance index associated with software development. The system includes a server computing device configured to receive software development performance data associated with a company, the software development performance data distributed among a plurality of categories and corresponding to a first period of time. The server computing device is configured to determine a current score for each of the plurality of categories based upon the software development performance data associated with the category. The server computing device is configured to aggregate the current scores for each of the plurality of categories to generate a current index score for the company for the first period of time. The server computing device is configured to compare the current index score to index scores for the company corresponding to prior periods of time to determine a change in index score over time.

The invention, in another aspect, features a computer program product, tangibly embodied in a non-transitory computer readable storage medium, for generating a functional performance index associated with software development. The computer program product includes instructions operable to cause a server computing device to receive software development performance data associated with a company, the software development performance data distributed among a plurality of categories and corresponding to a first period of time. The computer program product includes instructions operable to cause the server computing device to determine a current score for each of the plurality of categories based upon the software development performance data associated with the category. The computer program product includes instructions operable to cause the server computing device to aggregate the current scores for each of the plurality of categories to generate a current index score for the company for the first period of time. The computer program product includes instructions operable to cause the server computing device to compare the current index score to index scores for the company corresponding to prior periods of time to determine a change in index score over time.

Any of the above aspects can include one or more of the following features. In some embodiments, the server computing device identifies one or more trends associated with the index score for the company over time and associates the one or more trends to changes in the software development performance data over time. In some embodiments, the categories includes product cost ratio, revenue per employee, employee satisfaction, customer satisfaction, release frequency, release stabilization, cycle time, installed version index, usage index, innovation rate and total defects. In some embodiments, the step of determining a score for each of the plurality of categories includes determining a sub-value for each of the plurality of categories based upon the software development performance data for the category, comparing the sub-value to a sub-value index for the category, and assigning a score to the category that corresponds to the position of the determined sub-value in the sub-value index.

In some embodiments, the step of aggregating the scores for each of the plurality of categories includes determining a weighted value for each of the scores based upon a weight assigned to the corresponding category, calculating a subtotal score based upon the weighted values, and comparing the subtotal score to a predetermined maximum score to generate the index score. In some embodiments, the comparison of the subtotal score to the predetermined maximum score results in a percentage value.

In some embodiments, the step of comparing the generated index score to index scores for the company corresponding to prior periods of time includes comparing the current scores for a plurality of categories to scores for the plurality of categories corresponding to prior periods of time. In some embodiments, the server computing device transmits the current index score, the current scores for the plurality of categories, one or more index scores associated with a previous period of time, and scores for the plurality of categories associated with the previous period of time to a client computing device for display to a user.

In some embodiments, the current scores for the plurality of categories and the scores for the plurality of categories associated with the previous period of time are displayed in a spider chart. In some embodiments, each category is represented by a radius in the spider chart.

In some embodiments, the software development performance data for one or more of the categories is not received and the server computing device assigns a minimum value to the current score for the category. In some embodiments, the software development performance data corresponds to a subset of the company. In some embodiments, the subset is a product line, group, or business unit.

In some embodiments, the server computing device compares the current index score to index scores for one or more other companies. In some embodiments, the company has at least one characteristic in common with the one or more other companies. In some embodiments, the company uses a different currency than the one or more other companies and the server computing device standardizes the currencies used by the company and the one or more other companies prior to comparing the current index score to index scores for one or more other companies. In some embodiments, the server computing device analyzes the current index score in relation to an industry benchmark.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for generating a functional performance index associated with software development.

FIG. 2 is a flow diagram of a method for generating a functional performance index associated with software development.

FIG. 3 is a diagram of an exemplary user interface for submitting data to be used in generating a functional performance index associated with software development.

FIG. 4 is a diagram of an exemplary determination of a current score for one category based upon software development performance data.

FIG. 5 is a diagram of an exemplary determination of a functional performance index associated with software development across a plurality of categories.

FIG. 6 is a diagram of an exemplary spider chart depicting changes to scores over time for a plurality of categories included in a functional performance index associated with software development.

FIG. 7 is a diagram of an exemplary functional performance index associated with software development, including changes to the index over time.

FIG. 8 is a diagram of exemplary trend data for a plurality of categories included in a functional performance index associated with software development.

### DETAILED DESCRIPTION

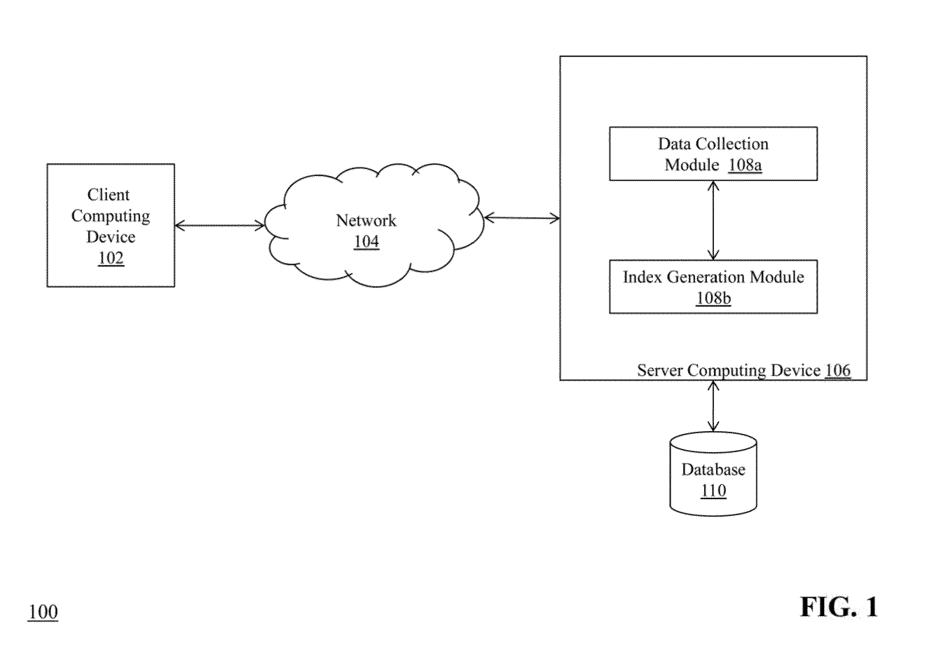

FIG. 1 is a block diagram of a system 100 for generating a functional performance index associated with software development, according to an embodiment of the invention. The system 100 includes a client computing device 102, a communications network 104, a server computing device 106 that includes a data collection module 108a and an index calculation module 108b, and a database 110.

The client computing device 102 connects to the server computing device 106 via the communications network 104 in order to submit data to be used by the server computing device 106 in generating a functional performance index associated with software development, and to receive data (e.g., reports, analyses) resulting from the generation and tracking of the functional performance index. Exemplary client devices include desktop computers, laptop computers, tablets, mobile devices, smartphones, and internet appliances. It should be appreciated that other types of computing devices that are capable of connecting to the server computing device 106 can be used without departing from the scope of invention. Although FIG. 1 depicts one client device 102 it should be appreciated that the system 100 can include any number of client devices.

The communication network 104 enables the client device 102 to communicate with the server computing device 106 in order to submit and receive data associated with the generation of the functional performance index. The network 104 may be a local network, such as a LAN, or a wide area network, such as the Internet and/or a cellular network. In some embodiments, the network 104 is comprised of several discrete networks and/or sub-networks (e.g., cellular to Internet) that enable the client device 102 to communicate with the server computing device 106.

The server computing device 106 is a combination of hardware and software modules that collect data from external sources (e.g., client device 102), generate the functional performance index, and provide data to external sources (e.g., client device 102, database 110). The server computing device 106 includes a data collection module 108a and an index generation module 108b. The modules 108a-108b are hardware and/or software modules that reside on the server computing device 106 to perform functions associated with receiving software development performance data from client computing devices, generating a functional performance index, tracking the functional performance index over time along with the underlying software development performance data, and providing reports and analyses to client computing devices based upon the index generation and tracking processes. In some embodiments, the functionality of the modules 108a-108b is distributed among a plurality of computing devices. It should be appreciated that any number of computing devices, arranged in a variety of architectures, resources, and configurations (e.g., cluster computing, virtual computing, cloud computing) can be used without departing from the scope of the invention. It should also be appreciated that, in some embodiments, the functionality of the modules 108a-108b can be distributed such that any of the modules 108a-108b are capable of performing any of the functions described herein without departing from the scope of the invention. For example, in some embodiments, the functionality of the modules 108a-108b can be merged into a single module.

The data collection module 108a receives software development performance data submitted by a client computing device (e.g., device 102) for the purpose of generating the functional performance index. In some embodiments, the data collection module 108a also generates user interface data to be presented on the client device 102 from which the software development performance data can be collected (e.g., a form for entry of the data). In some embodiments, the module 108a also generates user interface data to be presented on the client device 102 which includes the results of the functional performance index generation and tracking processes (e.g., reports, analyses), to be described in greater detail below.

The server computing device 106 also includes an index generation module 108b. The index generation module 108b is coupled to the module 108a. The index generation module 108b performs functions and algorithms to generate the functional performance index based upon the received software development performance data and to store the results of the index generation process (e.g., in database 110).

The system 100 also includes a database 110. The database 110 is coupled to the server computing device 106 and stores data used by the server computing device 106 to perform the index generation and tracking processes. The database 110 can be integrated with the server computing device 106 or be located on a separate computing device. An example database that can be used with the system 100 is MySQL™ available from Oracle Corp. of Redwood City, Calif.

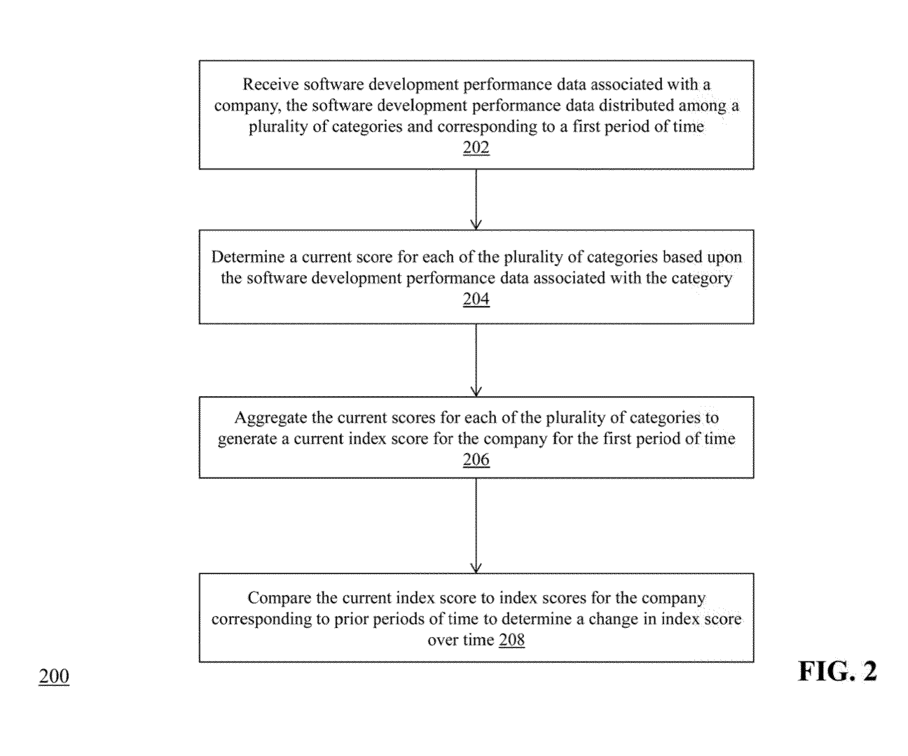

FIG. 2 is a flow diagram of a method 200 for generating a functional performance index associated with software development, using the system 100 of FIG. 1. The data collection module 108a of the server computing device 106 receives (202) software development performance data associated with a company from client computing device 102. The software development performance data is distributed among a plurality of categories and corresponds to a first period of time (e.g., the prior development cycle, the prior quarter, the prior twelve months, and the like).

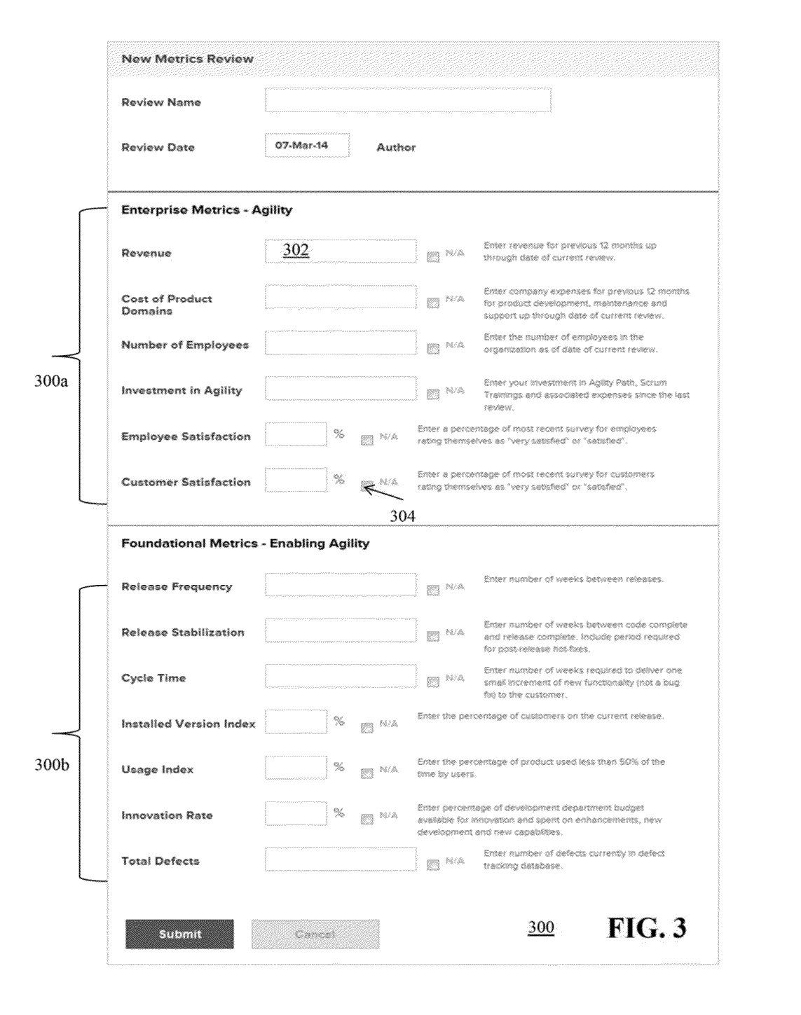

For example, the data collection module 108a can generate a user interface to be presented on the client device 102 in which a user of client device 102 can enter the software development performance data. FIG. 3 is a diagram of an exemplary user interface 300 for submitting data to be used in generating a functional performance index associated with software development. As shown in FIG. 3, the user interface 300 has a series of data entry fields (e.g., data field 302), each associated with a category of software development performance data. For example, data field 302 is labeled ‘Revenue’ and includes instructions prompting a user to ‘enter revenue for previous 12 months up through date of current review.’

The categories are assigned to one of two groups: the Enterprise Metrics—Agility group 300a and the Foundational Metrics—Enabling Agility group 300b. The categories in the Enterprise Metrics—Agility group 300a are as follows:
Revenue—enter revenue for previous twelve months up through date of current review;
Cost of Product Domains—enter company expenses for previous twelve months for product development, maintenance and support up through date of current review;
Number of Employees—enter the number of employees in the organization as of date of current review;
Employee Satisfaction—enter a percentage of most recent survey for employees rating themselves ‘very satisfied’ or ‘satisfied’;
Customer Satisfaction—enter a percentage of most recent survey for customers rating themselves ‘very satisfied’ or ‘satisfied.’

The categories in the Foundational Metrics—Enabling Agility group 300b are as follows:
Release Frequency—enter number of weeks between releases;
Release Stabilization—enter number of weeks between code complete and release complete. Include period required for post-release hot-fixes;
Cycle Time—enter number of weeks required to deliver one small increment of new functionality (not a bug fix) to the customer;
Installed Version Index—enter the percentage of customers on the current release;
Usage Index—enter the percentage of product used less than 50% of the time by users;
Innovation Rate—enter percentage of development department budget available for innovation and spent on enhancements, new development and new capabilities;
Total Defects—enter number of defects currently in defect tracking database.

Another category, Investment in Agility, is included in the Enterprise Metrics—Agility group 300a shown in FIG. 3. The Investment in Agility category relates to the company's investment in Agility Path, Scrum Trainings and associated expenses since the last review. The value entered by the company in the Investment in Agility category can be used by the system in relation to the functional performance index to determine whether a company's expenditure in frameworks for agile software development have provided a corresponding change in the functional performance index.

It should be appreciated that other groups and categories of software development performance data are included within the scope of invention, and the embodiments described herein are not limited to only the above-referenced groups and categories. It should also be appreciated that any of the above categories can be merged or combined to result in another category, or that any of the above categories can be moved to different groups or removed from the determination of a functional performance index. For example, in the embodiment described herein, the Revenue and Cost of Product Domains categories are not treated as separate categories; instead, the software performance development data for these categories are used together as part of a Product Cost/Revenue Category. Also, the definitions for the categories listed above are exemplary and other definitions can be contemplated within the scope of the methods and systems described herein. For example, the definition for the Release Frequency category can be adapted to utilize a different increment of time (e.g., days, months).

Each data field also includes a check box (e.g., N/A check box 304) that, when checked, indicates the user does not have any data to enter into that particular field. For example, if the user does not know what percentage of his customers are ‘very satisfied’ or ‘satisfied’, the user can select the check box 304 next to the Customer Satisfaction category data entry field.

The user interface 300 also includes a date field to record the date on which the software development performance data is submitted, and a name field used to identify the particular review for which the data is being submitted. Once the user has entered data into the user interface 300 for the applicable categories, the user can select the Submit button to transmit the data from client device 102 to the data collection module 108a on server computing device 106 via network 104.

The data collection module 108a receives the submitted software development performance data for each of the categories and stores the data in database 110. The index generation module 108b also receives the submitted data (either from database 110 or from the data collection module 108a) and generates a functional performance index for the company based upon the submitted data.

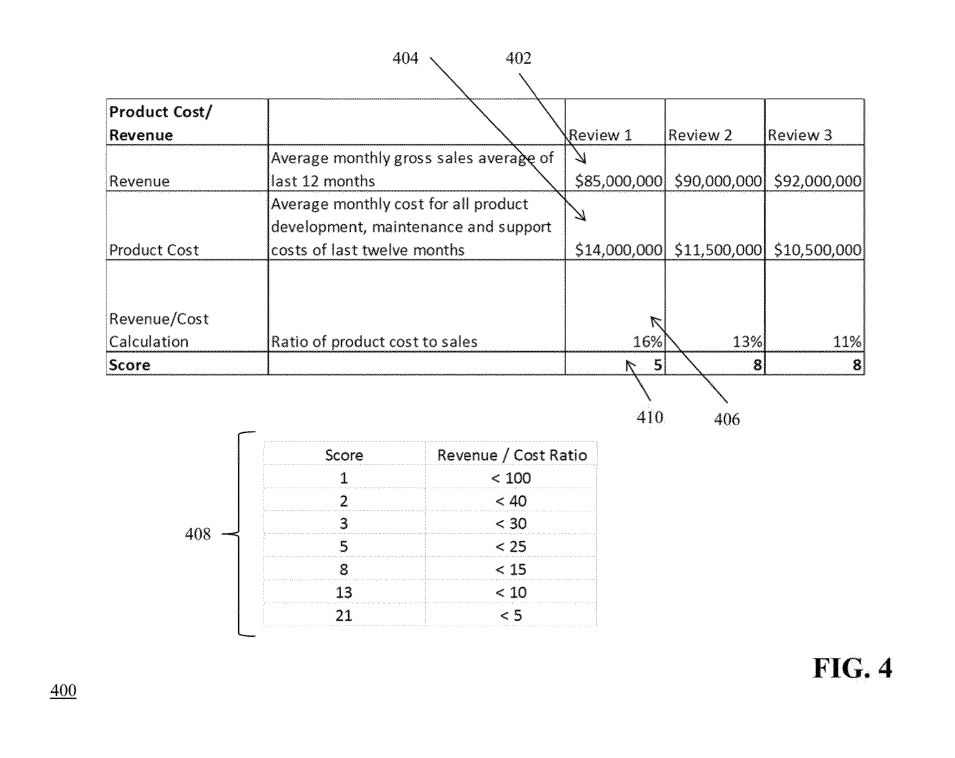

Turning back to FIG. 2, the index generation module 108b determines (204) a current score for each of the plurality of categories based upon the software development performance data associated with the category. FIG. 4 is a diagram 400 of an exemplary determination of a current score for one category (e.g., the Product Cost/Revenue category) based upon software development performance data. As set forth previously, the data fields associated with the Revenue category and Cost of Product Domains category are used as part of the score calculation for a single category—the Product Cost/Revenue category.

FIG. 4 depicts the submitted software development performance data for each of the Revenue (reference character 402) and Cost of Product Domains fields (reference character 404). As shown in FIG. 4, for Review 1, the Revenue was $85 m and the Product Cost was $14 m. It should be noted that FIG. 4 also includes software development performance data submitted by the company for subsequent review periods (e.g., Review 2 and Review 3).

The module 108b determines a ratio of product cost to sales (e.g., Revenue/Cost Calculation) by dividing the product cost by the revenue as follows: $14 m Product Cost/$85 m Revenue=16% Revenue-to-Cost ratio (reference character 406). The module 108b then compares the Revenue-to-Cost ratio 406 to a scale of values 408 in order to determine a current score for the company in the Product Cost/Revenue Category. Using the example in FIG. 4, the 16% Revenue-to-Cost ratio is assigned a score of 5 (reference character 410) because it is less than 25% but greater than 15%. It should be appreciated that the scale of values and ratios depicted in FIG. 4 are exemplary, and other scales and ratios of values can be used without departing from the scope of invention.

The exemplary score scale 408 shown in FIG. 4 is based off of the Fibonacci sequence of numbers, in that the score increases to the next digit in the Fibonacci sequence at each Revenue-to-Cost ratio breakpoint. For example, a Revenue-to-Cost ratio between 40 and 100 would be assigned a score of 1, while a Revenue-to-Cost ratio between 30 and 39 would be assigned a score of 2, and so forth. It should be appreciated that, although the Fibonacci sequence is depicted in FIG. 4, other scales and scoring systems can be used without departing from the scope of invention and the invention is not limited to use of the Fibonacci sequence.

For each of the categories identified above, the index generation module 108b determines a current score for the category in a similar manner to that depicted in FIG. 4. Certain categories can include computations performed by the module 108b before a score is assigned from the scale (as with the Product Cost/Revenue category), while for other categories the module 108b can simply assign a score from the scale based upon the software development performance data submitted from the client device 102 without any additional computations.

As set forth above, the user may have selected the check box in user interface 300 of FIG. 3 next to one or more of the software development performance data fields—indicating that the user does not have data available for that particular field. In this case, the index generation module 108b can assign the lowest possible score (e.g., 1) to that category in order to maintain the integrity of the index generation process and not have any invalid or missing data fields.

Also, as shown in FIG. 4, the Product Cost and Revenue data fields 402, 404 are represented in US dollars. The system 100 is capable of receiving data in any number of international currencies and converting the data into a standardized currency (e.g., through use of exchange rate data) so that companies in different regions of the world can still be compared despite their use of different denominations of currency.

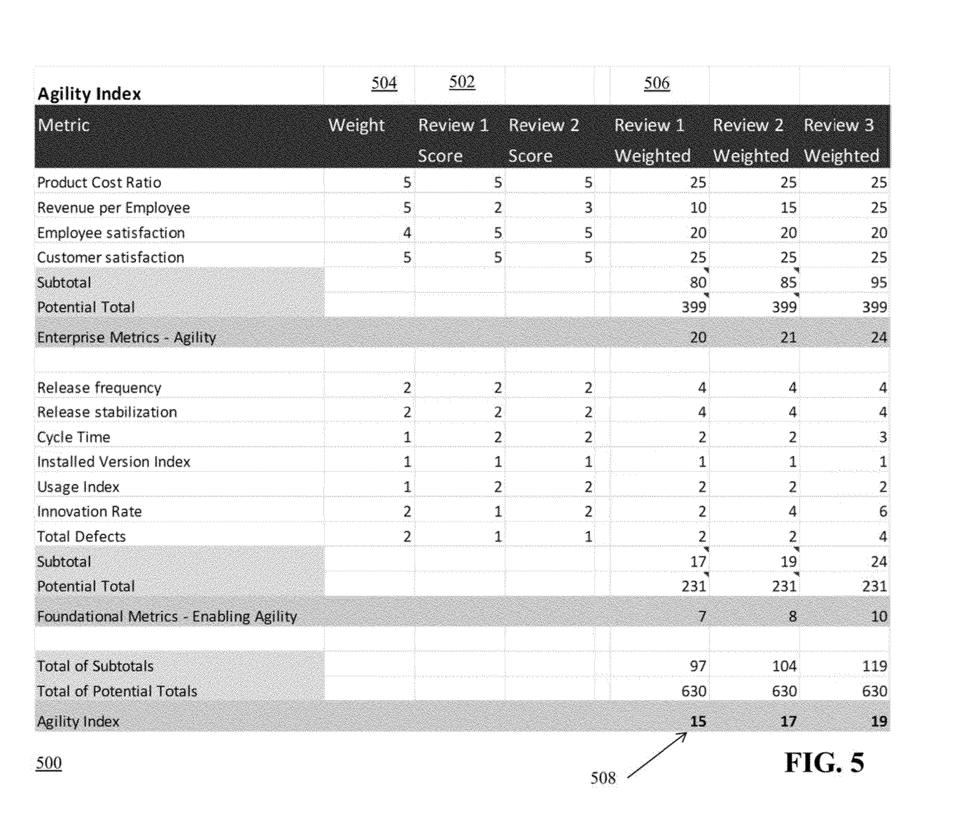

Returning to FIG. 2, once the index generation module 108b has determined a current score for each of the categories of software development performance data, the module 108b aggregates (206) the current scores for each of the plurality of categories to generate a current index score for the company for the first period of time. FIG. 5 is a diagram 500 of an exemplary determination of a functional performance index associated with software development across a plurality of categories. As shown in FIG. 5, each category (also called a metric) is listed in the left-hand column and the categories are listed according to group (e.g., Enterprise Metrics—Agility, Foundational Metrics—Enabling Agility). The current scores as previously determined by the index generation module 108b are shown in column 502 under Review 1 Score (e.g., the Product Cost Ratio category has a score of 5).

Each category is also assigned a weight value (e.g., on a scale from 1-5) in column 504. For example, the Product Cost Ratio category is assigned a weight value of 5, while the Usage Index category is assigned a weight value of 1. The current score for a category is multiplied by the assigned weight value to arrive at a weighted score for each category. For example, in the Product Cost Ratio category, the current score of 5 is multiplied by the assigned weight value of 5 to result in a weighted current score of 25 (column 506).

In this example, the categories in the Enterprise Metrics—Agility group (i.e., those associated with software development cost, revenue and satisfaction) are weighted higher than categories in the Foundational Metrics—Enabling Agility group (i.e., those associated with software development timelines and remediation). It should be appreciated that different types of weight determinations and apportionment can be used within the scope of invention.

For each group (e.g., Enterprise Metrics—Agility and Foundational Metrics—Enabling Agility), the module 108b determines a subtotal weighted score by adding together each of the weighted scores for the individual categories in the group. For example, in FIG. 5, the subtotal score for the Enterprise Metrics—Agility group is 80 (25+10+20+25). The module 108b compares the subtotal score to a potential total score to determine an overall score for the group. The potential total score is the highest possible score for the group—which is calculated by multiplying the weight for each category by the highest possible current score (e.g., 21) that could have been assigned to that category. For example, the Enterprise Metrics—Agility group has a potential total score of 399—or (5×21)+(5×21)+(4×21)+(5×21). The module 108b compares the actual subtotal score (i.e., 80) against the potential total score (i.e., 399) to determine the overall score for the group (i.e., 20 or 80/399).

Once the index generation module has determined the subtotal score for each group, the module 108b performs a similar calculation to generate a current index score for the company. Using the example in FIG. 5, the total of subtotal scores for both the Enterprise Metrics—Agility group and the Foundational Metrics—Enabling Agility group is 97 (i.e., 80+17). The total of potential total scores for both the Enterprise Metrics—Agility group and the Foundational Metrics—Enabling Agility group is 630 (i.e., 399+231). The module 108b divides the total of subtotal scores by the total of potential total scores to arrive at the current index score (also called the Agility Index) for the company: 97/630=15 (reference character 508). The index generation module 108b can store each of the above-referenced data points (including the interim calculations) in database 110 for future reference and analysis.

Returning to FIG. 2, now that the index generation module 108b has determined a current index score for the company (e.g., 15), the module 108b compares (208) the current index score to one or more index scores for the company corresponding to prior periods of time to determine a change in index score over time. Comparing a current index score to prior index scores can provide useful insight into improvements or decline in software development performance at a company. In addition, the results of comparison by the module 108b can be conveyed to the client computing device 102 in many different forms, including graphical analyses, charts, reports, and the like.

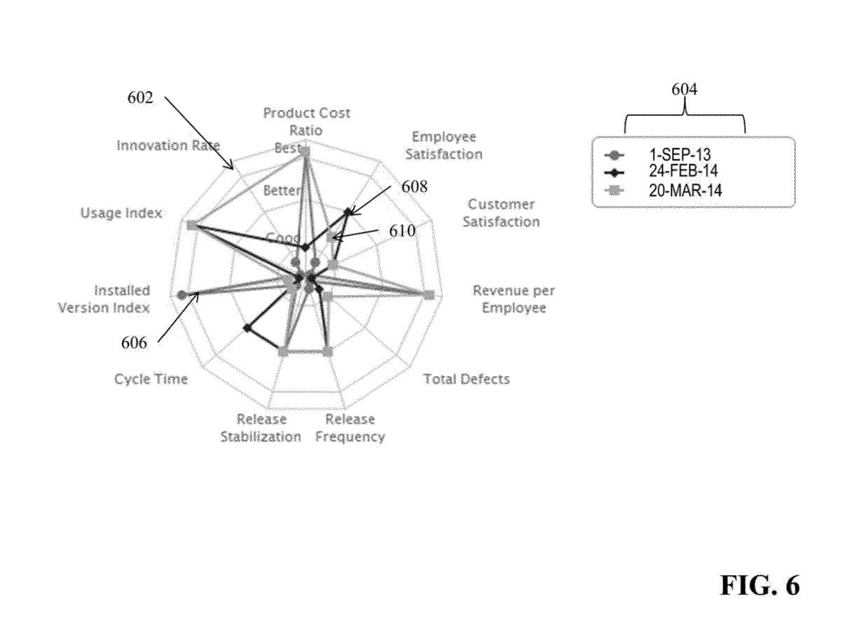

FIG. 6 is a diagram of an exemplary spider chart 600 depicting changes to scores over time for a plurality of categories included in a functional performance index associated with software development. As shown in FIG. 6, each radius of the spider chart (e.g., radius 602) represents a different category associated with the software development performance data used in generating the index score. In addition, each line in the spider chart (denoted in the legend 604) corresponds to the score assigned to each category by the index generation module 108b for each period of time. For example, line 606 consists of a series of points on each radius, where each point represents the score for the particular category for that radius. As a result, the spider chart 600 clearly and efficiently shows the relative changes to scores for particular categories across review periods. In one example, for Employee Satisfaction, the score went from ‘Better’ during the Feb. 24, 2014 review period (reference character 608) to ‘Good’ during the Mar. 20, 2014 review period (reference character 610).

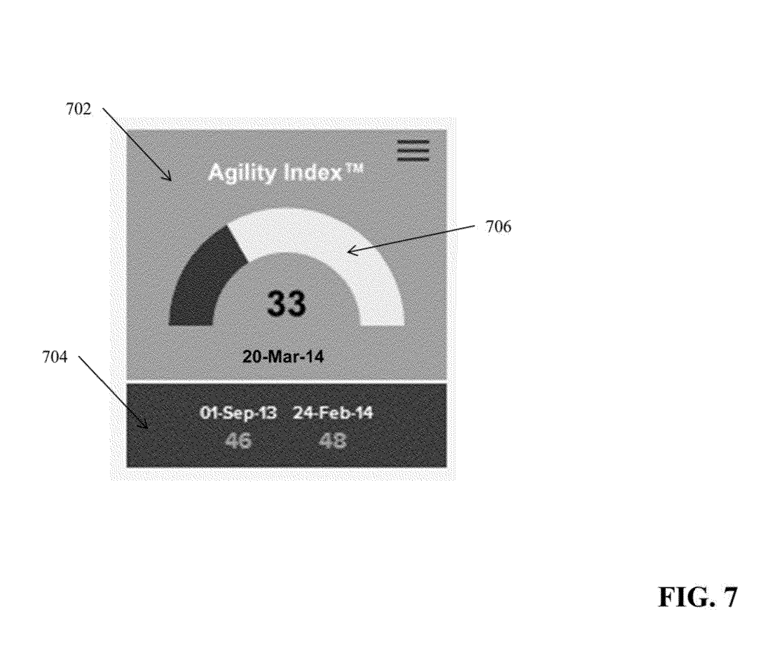

FIG. 7 is a diagram 700 of an exemplary functional performance index associated with software development, including changes to the index over time. As shown in FIG. 7, the index score for the current period of time (e.g., a score of 33 for Mar. 20, 2014) is depicted in the upper portion of the diagram (reference character 702) and index scores for the two previous periods of time (e.g., 46 for Sep. 1, 2013 and 48 for Feb. 24, 2014) are depicted in the lower portion of the diagram (reference character 704). The diagram also includes a visual indicator 706 that shows how the current index score (denoted by the shaded area in indicator 706) is positioned in relation to a spectrum of scores, with the highest score being on the far right. The diagram 700 provides an easy way for a user to see how the index score for his or her company has changed over time and how the current index score compares to previously-recorded index scores.

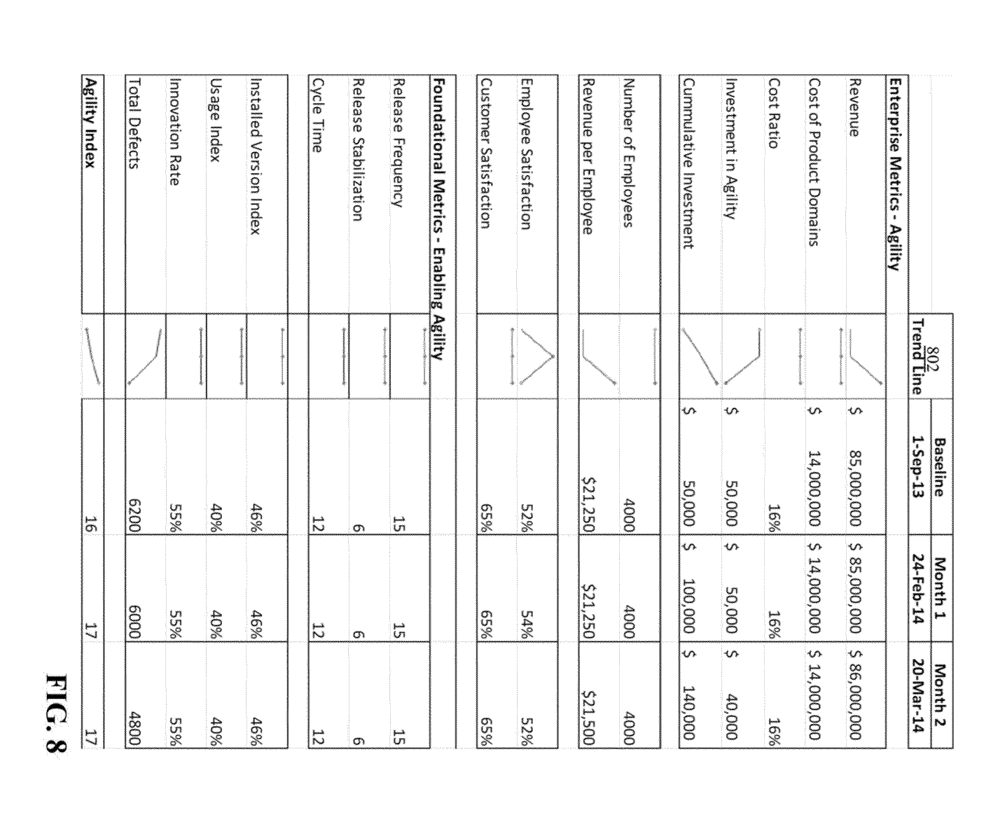

FIG. 8 is a diagram 800 of exemplary trend data for a plurality of categories included in a functional performance index associated with software development. As shown in FIG. 8, a trend line (column 802) is depicted for each category that is included in the functional performance index, as well as a trend line for the overall functional performance index. The trend line is a graphical representation of the change in the respective data points over time. For example, the Revenue category went from $85 m in Sep. 1, 2013 to $86 m in Mar. 20, 2014. As a result, the corresponding trend line shows an uptick relating to the increase in Revenue.

It should be appreciated that, while the above embodiments describe a company or organization-wide analysis of software development performance data, certain subsets of a company or organization can also be monitored, analyzed, and tracked using the methods and systems described herein. For example, a company may wish to generate a functional performance index for software development relating to a subset of the company, such as a specific product line, a group, a division, or a business unit. The above-referenced methods and systems can be configured to receive software development performance data associated with the subset, generate an index score for the subset, and track the index scores for the subset over time. This approach enables the organization to understand its software development infrastructure at a more granular level, and focus on specific improvements and changes to the development framework for the subset—leading to greater effectiveness and more targeted improvement.

Another feature provided by the methods and systems described herein is the ability to compare companies/products across industries and/or across global boundaries. For example, the functional performance index for companies within the same sector or industry can be compared to determine the relative success of the companies with respect to software development. As can be appreciated, industry benchmarks can be established regarding the functional performance index and a company's individual performance index can be evaluated against the benchmark data. In addition, as a company's performance index changes over time, the associated trend data can be utilized to see how a company's index has changed relative to the industry benchmark or relative to its peers/competitors. Also, a company's functional performance index can be analyzed in relation to other traditional market or company-specific metrics (e.g., financial data, employment data, and the like). Further, as described above, the currency conversion capability provided by the system enables the comparison of companies from different regions of the world that may use different currencies.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein.

What is claimed is:

1. A computerized method for generating a functional performance index associated with software development, the method comprising:
receiving, by a server computing device, software development performance data associated with a company, the software development performance data distributed among a plurality of categories and corresponding to a first period of time;
determining, by the server computing device, a current score for each of the plurality of categories based upon the software development performance data associated with the category;
aggregating, by the server computing device, the current scores for each of the plurality of categories to generate a current index score for the company for the first period of time; and
comparing, by the server computing device, the current index score to index scores for the company corresponding to prior periods of time to determine a change in index score over time.

2. The method of claim 1, further comprising:
identifying, by the server computing device, one or more trends associated with the index score for the company over time; and
associating, by the server computing device, the one or more trends to changes in the software development performance data over time.

3. The method of claim 1, wherein the categories includes product cost ratio, revenue per employee, employee satisfaction, customer satisfaction, release frequency, release stabilization, cycle time, installed version index, usage index, innovation rate and total defects.

4. The method of claim 1, the step of determining a score for each of the plurality of categories further comprising:
determining, by the server computing device, a sub-value for each of the plurality of categories based upon the software development performance data for the category;
comparing, by the server computing device, the sub-value to a sub-value index for the category; and
assigning, by the server computing device, a score to the category that corresponds to the position of the determined sub-value in the sub-value index.

5. The method of claim 1, the step of aggregating the scores for each of the plurality of categories further comprising:
determining, by the server computing device, a weighted value for each of the scores based upon a weight assigned to the corresponding category;
calculating, by the server computing device, a subtotal score based upon the weighted values; and
comparing, by the server computing device, the subtotal score to a predetermined maximum score to generate the index score.

6. The method of claim 5, wherein the comparison of the subtotal score to the predetermined maximum score results in a percentage value.

7. The method of claim 1, the step of comparing the generated index score to index scores for the company corresponding to prior periods of time further comprising: comparing, by the server computing device, the current scores for a plurality of categories to scores for the plurality of categories corresponding to prior periods of time.

8. The method of claim 1, further comprising: transmitting, by the server computing device, the current index score, the current scores for the plurality of categories, one or more index scores associated with a previous period of time, and scores for the plurality of categories associated with the previous period of time to a client computing device for display to a user.

9. The method of claim 1, wherein the current scores for the plurality of categories and the scores for the plurality of categories associated with the previous period of time are displayed in a spider chart.

10. The method of claim 9, wherein each category is represented by a radius in the spider chart.

11. The method of claim 1, wherein the software development performance data for one or more of the categories is not received, the method further comprising: assigning, by the server computing device, a minimum value to the current score for the category.

12. The method of claim 1, wherein the software development performance data corresponds to a subset of the company.

13. The method of claim 12, wherein the subset is a product line, group, or business unit.

14. The method of claim 1, further comprising comparing, by the server computing device, the current index score to index scores for one or more other companies.

15. The method of claim 14, wherein the company has at least one characteristic in common with the one or more other companies.

16. The method of claim 14, wherein the company uses a different currency than the one or more other companies and the server computing device standardizes the currencies used by the company and the one or more other companies prior to comparing the current index score to index scores for one or more other companies.

17. The method of claim 1, further comprising analyzing, by the server computing device, the current index score in relation to an industry benchmark.

18. A system for generating a functional performance index associated with software development, the system comprising a server computing device configured to:
receive software development performance data associated with a company, the software development performance data distributed among a plurality of categories and corresponding to a first period of time;
determine a current score for each of the plurality of categories based upon the software development performance data associated with the category;
aggregate the current scores for each of the plurality of categories to generate a current index score for the company for the first period of time; and
compare the current index score to index scores for the company corresponding to prior periods of time to determine a change in index score over time.

19. The system of claim 18, the server computing device further configured to:
identify one or more trends associated with the index score for the company over time; and
associate the one or more trends to changes in the software development performance data over time.

20. The system of claim 18, wherein the categories includes product cost ratio, revenue per employee, employee satisfaction, customer satisfaction, release frequency, release stabilization, cycle time, installed version index, usage index, innovation rate and total defects.

21. The system of claim 18, the step of determining a score for each of the plurality of categories further comprising:
determining a sub-value for each of the plurality of categories based upon the software development performance data for the category;
comparing the sub-value to a sub-value index for the category; and
assigning a score to the category that corresponds to the position of the determined sub-value in the sub-value index.

22. The system of claim 18, the step of aggregating the scores for each of the plurality of categories further comprising:
determining a weighted value for each of the scores based upon a weight assigned to the corresponding category;
calculating a subtotal score based upon the weighted values; and
comparing the subtotal score to a predetermined maximum score to generate the index score.

23. The system of claim 22, wherein the comparison of the subtotal score to the predetermined maximum score results in a percentage value.

24. The system of claim 18, the step of comparing the generated index score to index scores for the company corresponding to prior periods of time further comprising: comparing the current scores for a plurality of categories to scores for the plurality of categories corresponding to prior periods of time.

25. The system of claim 18, the server computing device further configured to transmit the current index score, the current scores for the plurality of categories, one or more index scores associated with a previous period of time, and scores for the plurality of categories associated with the previous period of time to a client computing device for display to a user.

26. The system of claim 18, wherein the current scores for the plurality of categories and the scores for the plurality of categories associated with the previous period of time are displayed in a spider chart.

27. The system of claim 26, wherein each category is represented by a radius in the spider chart.

28. The system of claim 18, wherein the software development performance data for one or more of the categories is not received, the server computing device further configured to assign a minimum value to the current score for the category.

29. The system of claim 18, wherein the software development performance data corresponds to a subset of the company.

30. The system of claim 29, wherein the subset is a product line, group, or business unit.

31. The system of claim 18, further comprising comparing, by the server computing device, the current index score to index scores for one or more other companies.

32. The system of claim 31, wherein the company has at least one characteristic in common with the one or more other companies.

33. The system of claim 31, wherein the company uses a different currency than the one or more other companies and the server computing device standardizes the currencies used by the company and the one or more other companies prior to comparing the current index score to index scores for one or more other companies.

34. The system of claim 18, further comprising analyzing, by the server computing device, the current index score in relation to an industry benchmark.

35. A computer program product, tangibly embodied in a non-transitory computer readable storage medium, for generating a functional performance index associated with software development, the computer program product including instructions operable to cause a server computing device to:
receive software development performance data associated with a company, the software development performance data distributed among a plurality of categories and corresponding to a first period of time;
determine a current score for each of the plurality of categories based upon the software development performance data associated with the category;
aggregate the current scores for each of the plurality of categories to generate a current index score for the company for the first period of time; and
compare the current index score to index scores for the company corresponding to prior periods of time to determine a change in index score over time.
